(19) United States
(12) Patent Application Publication
(10) Pub. No.: US 2025/0322664 A1
(43) Pub. Date: Oct. 16, 2025

(54) INTELLIGENT SECURITY SYSTEM

(71) Applicant: EdgeDX Co., Ltd., Seoul (KR)

(72) Inventor: Dong Uk PARK, Seoul (KR)

(73) Assignee: EdgeDX Co., Ltd., Seoul (KR)

(21) Appl. No.: 18/954,281

(22) Filed: Nov. 20, 2024

(30) Foreign Application Priority Data
Apr. 15, 2024 (KR) 10-2024-0049812

(51) Int. Cl. G06V 20/52; G06F 40/205; G06T 11/20; G06V 20/40; G08B 13/196

(52) U.S. Cl. CPC G06V 20/52; G06F 40/205; G06T 11/203; G06V 20/41; G06V 20/44; G08B 13/19602

(57) ABSTRACT

Provided is an intelligent security system, which generates a more specific query about a situation in which video is captured and query to generative AI to be able to reduce ambiguity in result analysis different from intent, thereby more accurately identifying a security event.

### CROSS-REFERENCE TO RELATED APPLICATION

This application claims priority to and the benefit of Korean Patent Application No. 10-2024-0049812, filed on Apr. 15, 2024, the disclosure of which is incorporated herein by reference in its entirety.

### BACKGROUND OF THE INVENTION

### Field of the Invention

The present invention relates to video security technology that analyzes video acquired by a CCTV, etc. to generate a security event, and more particularly to an intelligent security system using generative artificial intelligence (AI).

### Description of the Related Art

Image recognition technology based on generative AI, such as OpenAI's GPT-4 and Google's Gemini, has the ability to understand the inherent meaning of an image and future possibilities by learning from descriptions, text, and sequence data provided together with the image.

However, such a generative AI-based image recognition model has difficulty in specifying the scope of results when compared to a discriminative model such as a deep learning-based object recognition model that classifies input data according to a certain criterion, and there is ambiguity in result analysis different from intent.

Therefore, the inventor has studied an intelligent security system that may generate a more specific query about a situation in which video is captured and query to the generative AI to be able to reduce ambiguity in result analysis different from intent, thereby identifying a more accurate security event.
(Patent Document 1) Republic of Korea Registered Patent No. 10-2541221 (Announced on Jun. 13, 2023)

### SUMMARY OF THE INVENTION

An object of the present invention is to provide an intelligent security system that may generate a more specific query about a situation in which video is captured and query to the generative AI to be able to reduce ambiguity in result analysis different from intent, thereby more accurately identifying a security event.

In accordance with an aspect of the present invention, the above and other objects can be accomplished by the provision of an intelligent security system including an artificial intelligence (AI) video analyzer configured to process a video signal input from a camera and generate object description information that describes an object included in the video, an intelligent query generator configured to generate a query including a description of the video from the object description information output by the AI video analyzer, and a security event processor configured to input the query generated by the intelligent query generator to generative AI, process a response by the generative AI, and identify a security event.

According to an additional aspect of the present invention, the AI video analyzer may include an object recognition unit configured to process the video signal input from the camera and extract an object included in the video, an object description text generation unit configured to generate object description text information describing the object extracted by the object recognition unit, an object description graphic generation unit configured to generate object description graphic information describing the object extracted by the object recognition unit, an object description graphic editing unit configured to display an area of the object extracted by the object recognition unit as a bounding box in at least one piece of still video extracted from the video signal, and to process a graphic annotation by adding the object description graphic information generated by the object description graphic generation unit to a region around the area of the object displayed as the bounding box in the still video, and an object description information output unit configured to output the object description text information generated by the object description text generation unit and the object description graphic information graphically annotated by the object description graphic editing unit to the intelligent query generator.

According to an additional aspect of the present invention, the object description graphic information may include a graphic that indicates a movement line of the object.

According to an additional aspect of the present invention, the security event processor may include a parsing unit configured to parse a response from the generative AI to extract security-related keywords, a security event identification unit configured to analyze the security-related keywords extracted by the parsing unit to determine whether a specific security event has occurred, and a security event response unit configured to output response information for the security event that has occurred when the security event identification unit determines that the specific security event has occurred.

According to an additional aspect of the present invention, the intelligent security system may further include a multimodal AI analyzer configured to process sensing information input from at least one sensor node, generate multimodal information, and output the multimodal information to the intelligent query generator.

According to an additional aspect of the present invention, the sensor node may include at least one of an acoustic sensor for detecting sound, an olfactory sensor for detecting smell, a distance sensor for detecting distance, a temperature sensor for detecting temperature, a humidity sensor for detecting humidity, an illuminance sensor for detecting illuminance, and a concentration sensor for detecting concentration.

According to an additional aspect of the present invention, the multimodal AI analyzer may generate multimodal information including at least one of sound description information obtained by analyzing an acoustic signal input from the acoustic sensor, smell description information obtained by analyzing smell signal input from the olfactory sensor, distance description information obtained by analyzing a distance signal input from the distance sensor, temperature description information obtained by analyzing a temperature signal input from the temperature sensor, humidity description information obtained by analyzing a humidity signal input from the humidity sensor, illuminance description information obtained by analyzing a humidity signal input from the illuminance sensor, or concentration description information obtained by analyzing a concentration signal input from the concentration sensor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram of network connection of an intelligent security system according to the present invention;

FIG. 2 is a block diagram illustrating a configuration of an embodiment of the intelligent security system according to the present invention;

FIGS. 3A and 3B are diagrams illustrating a query generated by the intelligent security system according to the present invention;

FIGS. 4A and 4B are diagrams illustrating a response of generative AI to a query generated by the intelligent security system according to the present invention;

FIG. 5 is a block diagram illustrating a configuration of an embodiment of an AI video analyzer of the intelligent security system according to the present invention;

FIG. 6 is a block diagram illustrating a configuration of an embodiment of a security event processor of the intelligent security system according to the present invention;

FIG. 7 is a diagram illustrating a query that further reflects multimodal information generated by a multimodal AI analyzer of the intelligent security system according to the present invention; and

FIG. 8 is a diagram illustrating a response of generative AI to a query that further reflects multimodal information generated by the multimodal AI analyzer of the intelligent security system according to the present invention.

### DETAILED DESCRIPTION OF THE INVENTION

Hereinafter, the present invention will be described in detail through preferred embodiments described with reference to the attached drawings so that those skilled in the art may easily understand and reproduce the embodiments. Even though specific embodiments are illustrated in the drawings and related detailed descriptions are given, the specific embodiments are not intended to limit various embodiments of the present invention to any particular form.

In describing the present invention, when it is determined that a detailed description of a related known function or configuration may unnecessarily obscure the gist of the embodiments of the present invention, the detailed description will be omitted.

When a component is mentioned as being “coupled” or “connected” to another component, it is understood that the component may be directly coupled or connected to another component, or still another component may be present therebetween.

On the other hand, when a component is mentioned as being “directly coupled” or “directly connected” to another component, it should be understood that there are no other components therebetween.

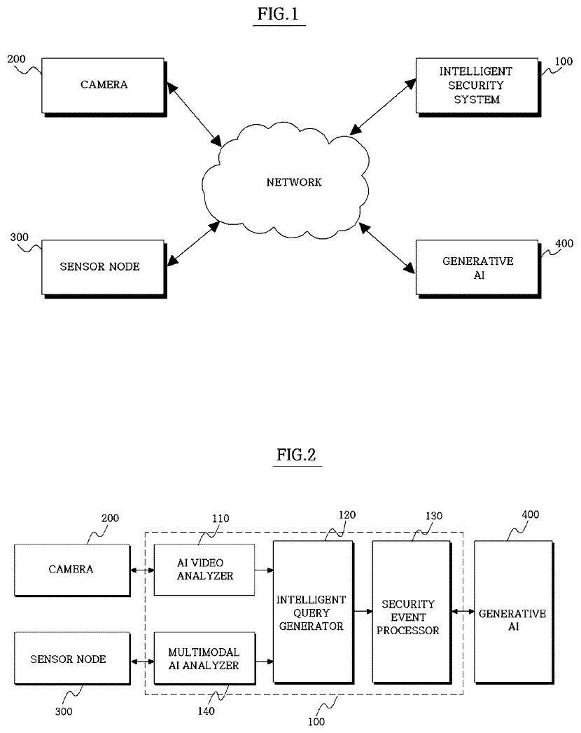

FIG. 1 is a schematic diagram of network connection of an intelligent security system according to the present invention. As illustrated in FIG. 1, an intelligent security system 100 according to the present invention is connected to a camera 200, at least one sensor node 300, and generative AI 400 through a network.

The intelligent security system 100 generates a security-related query to query the generative AI 400, analyzes a response from the generative AI 400, and identifies a specific security event. The camera 200 is a device installed in a security area to capture video of the security area, and may be a CCTV camera or an IP camera. The sensor node 300 senses various types of information, such as an environment of a location where the camera 200 is installed.

The generative AI 400 generates a response to a query input by the intelligent security system 100, which generates a query from video captured by the camera 200 and information sensed by the sensor node 300, and provides the response to the query to the intelligent security system 100.

FIG. 2 is a block diagram illustrating a configuration of an embodiment of the intelligent security system according to the present invention. As illustrated in FIG. 2, the intelligent security system 100 according to this embodiment includes an AI video analyzer 110, an intelligent query generator 120, and a security event processor 130.

The AI video analyzer 110 processes a video signal input from the camera 200 and generates object description information that describes an object included in the corresponding video. For example, the object description information may include object description text information and object description graphic information.

In this instance, the object description text information may be information, which describes an object or a situation around the object in text form, generated from camera metadata such as date, time, location, camera information, camera settings information, etc., or generated from object property data acquired by analyzing an object recognized in real time from video captured by the camera, such as type, age, gender, movement time, stop time, velocity, etc.

Meanwhile, the object description graphic information may be information which graphically describes an object or a situation around the object by tracking the object recognized in real time from video captured by the video to acquire a movement line, a movement trajectory, etc., or by receiving input of type, age, gender, movement time, stop time, velocity, etc. from a user.

The intelligent query generator 120 generates a query including a description of the corresponding video from the object description information output by the AI video analyzer 110. In this instance, the query may include object description text information and still video having graphically-annotated object description graphic information.

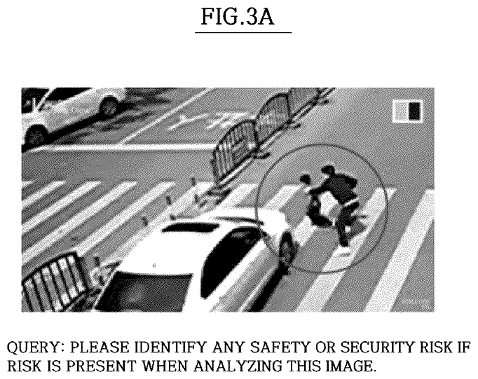

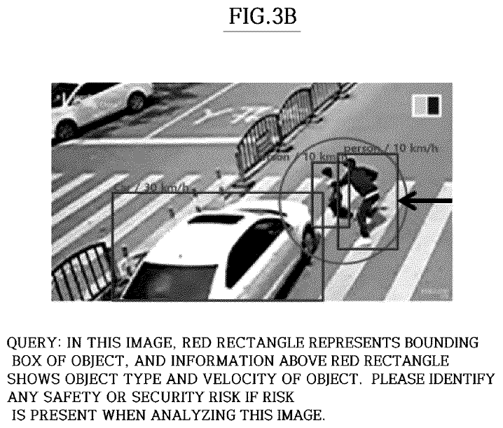

FIG. 3 is a diagram illustrating a query generated by the intelligent security system according to the present invention. FIG. 3A illustrates a typical query input to generative AI, and FIG. 3B illustrates a query generated by the intelligent security system according to the present invention and input to generative AI.

When still video on an upper side of FIG. 3B is examined in compared with still video on an upper side of FIG. 3A, it can be seen that object description graphic information is graphically annotated by overlaying a movement line, an object type, and a velocity on the still video. Meanwhile, when object description text information on a lower side of FIG. 3B is examined and compared with object description text information on a lower side of FIG. 3A, it can be seen a situation where the video is captured is more specifically described.

The security event processor 130 inputs query generated by the intelligent query generator 120 to the generative AI 400 and processes a response from the generative AI 400 to identify a security event. For example, the security event may be a variety of security-related events such as a traffic accident event, an intrusion detection event, a hazardous gas leak event, etc.

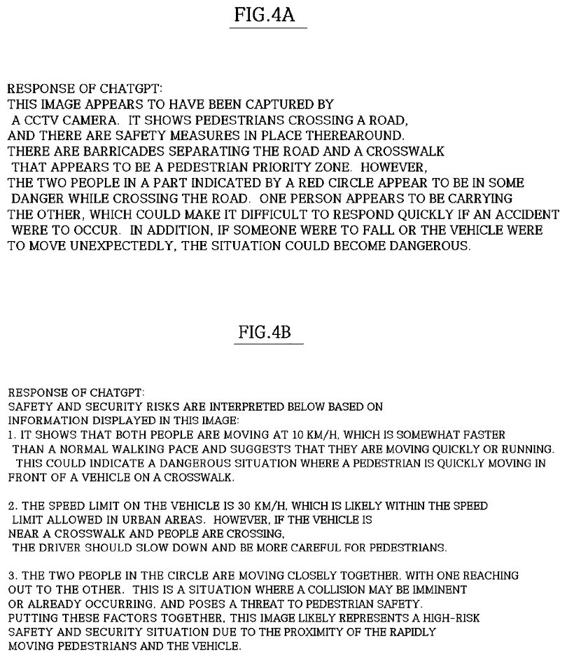

FIG. 4 is a diagram illustrating a response of generative AI to a query generated by the intelligent security system according to the present invention. FIG. 4A illustrates an example of a response when ChatGPT receives the query illustrated in FIG. 3A, and FIG. 4B illustrates an example of a response when ChatGPT receives the query illustrated in FIG. 3B.

With regard to a query generated by the intelligent security system 100 according to the present invention and input to the generative AI 400, since the object description graphic information is annotated in the still video and the object description text information more specifically describes a situation where the video is captured as illustrated in FIG. 3B, it can be seen that the generative AI 400 receiving input of the query and processing a response provides a response by more accurately analyzing intent of the query as in the response illustrated in FIG. 4B in comparison with the response illustrated in FIG. 4A.

By implementing in this way, the intelligent security system according to the present invention may generate a more specific query about a situation in which video is captured and query to the generative AI to be able to reduce ambiguity in result analysis different from intent, thereby more accurately identifying a security event. Therefore, it is possible to improve video security performance.

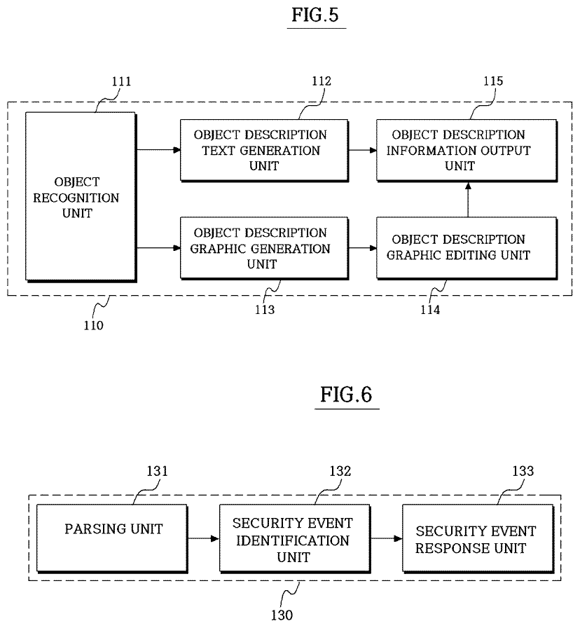

FIG. 5 is a block diagram illustrating a configuration of an embodiment of the AI video analyzer of the intelligent security system according to the present invention. As illustrated in FIG. 5, the AI video analyzer 110 according to this embodiment includes an object recognition unit 111, an object description text generation unit 112, an object description graphic generation unit 113, an object description graphic editing unit 114, and an object description information output unit 115.

The object recognition unit 111 processes a video signal input from the camera and extracts an object included in the video. For example, the object recognition unit 111 may be implemented to separate and extract an object area from video input from the camera, determine a type of object (person, animal, car, etc.), age, gender, etc. using an object recognition model, recognize a gesture using a 3D skeleton extraction model to obtain movement time, stop time, velocity, etc., and generate object property data.

The object description text generation unit 112 generates object description text information that describes an object extracted by the object recognition unit 111. For example, the object description text generation unit 112 may be implemented to generate object description text information that describes an object or a situation around the object in text form from camera metadata such as date, time, location, camera information, and camera setting information, and object property data such as type, age, gender, movement time, stop time, velocity, etc. generated by the object recognition unit 111.

The object description graphic generation unit 113 generates object description graphic information that describes the object extracted by the object recognition unit 111. In this instance, the object description graphic information may include a graphic that indicates the movement line of the object.

For example, the object description graphic generation unit 113 may be implemented to acquire a movement line, a movement trajectory, etc. of the object by tracking an object recognized in real time by the object recognition unit 111 from video captured by the camera, or to receive input of type, age, gender, movement time, stop time, velocity, etc. from the user through an object description graphic interface (not illustrated) and generate object description graphic information that graphically describes the object or the situation around the object.

The object description graphic editing unit 114 displays an area of the object extracted by the object recognition unit 111 as a bounding box in at least one piece of still video extracted from a video signal, and processes a graphic annotation by adding the object description graphic information generated by the object description graphic generation unit 113 to a region around the area of the object displayed as the bounding box in the still video. In this instance, the bounding box may be implemented as a 2D box or a 3D box.

Referring to the still video on the upper side of FIG. 3B, it can be seen that object areas of two people and an object area of one car are each displayed as a rectangular bounding box in the object description graphic editing unit 114. Meanwhile, it can be seen that a straight line indicating a movement line is overlaid on the right side of the person object, and an object type and a velocity are overlaid on each of the object areas of the two people and the object area of the one car, so that the object description graphic information generated by the object description graphic generation unit 113 is graphically annotated on the still video.

The object description information output unit 115 outputs object description text information generated by the object description text generation unit 112 and still video in which object description graphic information graphically annotated by the object description graphic editing unit 114 to the intelligent query generator 120.

By implementing in this way, in the present invention, the AI video analyzer 110 may process a video signal input from the camera 200, generate object description text information describing an object included in the video, and still video having graphically-annotated object description graphic information, and output the same to the intelligent query generator 120.

FIG. 6 is block diagram illustrating a configuration an embodiment of the security event processor of the intelligent security system according to the present invention. As illustrated in FIG. 6, the security event processor 130 according to this embodiment may include a parsing unit 131, a security event identification unit 132, and a security event response unit 133.

The parsing unit 131 parses a response from the generative AI 400 to extract security-related keywords. For example, the parsing unit 131 may parse the response from the generative AI 400 illustrated in FIG. 4B to extract security-related keywords such as “person”, “crosswalk”, “vehicle”, “fast”, “speed”, “dangerous situation”, “collision”, “imminent”, “occurrence”, “safety”, and “threat”.

The security event identification unit 132 analyzes security-related keywords extracted by the parsing unit 131 to determine whether a specific security event has occurred. In this instance, the security event may be a variety of security-related events such as a traffic accident event, an intrusion detection event, a hazardous gas leak event, etc.

For example, the security event identification unit 132 may determine that a “traffic accident” has occurred as a security event from security-related keywords extracted by the parsing unit 131, such as “person”, “crosswalk” “vehicle”, “fast”, “speed”, “dangerous situation”, “collision”, “imminent”, “occurrence”, “safety”, and “threat”.

When the security event identification unit 132 determines that a specific security event has occurred, the security event response unit outputs 133 response information for the security event that has occurred. For example, the response information for the security event may be, but is not limited to, a warning control signal for audibly or visually warning of an accident or dangerous situation, an operation control signal for operating various devices (for example, air purifiers, etc.) for resolving an accident or dangerous situation, an accident or dangerous report signal for reporting a dangerous situation to an emergency center (911 rescue team) or a control center (police station, etc.), etc.

By implementing in this way, in the present invention, the security event processor 130 may process a response by the generative AI to identify a security event and perform an appropriate response to the identified security event.

Meanwhile, according to an additional aspect of the present invention, the intelligent security system 100 may further include a multimodal AI analyzer 140. The multimodal AI analyzer 140 processes sensing information input from at least one sensor node 300, generates multimodal information, and outputs the multimodal information to the intelligent query generator 120.

In this instance, the sensor node 300 may include at least one of an acoustic sensor for detecting sound, an olfactory sensor for detecting smell, a distance sensor for detecting distance, a temperature sensor for detecting temperature, a humidity sensor for detecting humidity, an illuminance sensor for detecting illuminance, and a concentration sensor for detecting concentration.

Meanwhile, the multimodal AT analyzer 140 may be implemented to generate multimodal information including at least one of sound description information obtained by analyzing an acoustic signal input from the acoustic sensor, smell description information obtained by analyzing a smell signal input from the olfactory sensor, distance description information obtained by analyzing a distance signal input from the distance sensor, temperature description information obtained by analyzing a temperature signal input from the temperature sensor, humidity description information obtained by analyzing a humidity signal input from the humidity sensor, illuminance description information obtained by analyzing a humidity signal input from the illuminance sensor, or concentration description information obtained by analyzing a concentration signal input from the concentration sensor.

The intelligent query generator 120 receiving the multimodal information from the multimodal AI analyzer 140 a further generates query reflecting the multimodal information, queries the generative AI 400, and processes a response from the generative AI 400 to identify a security event.

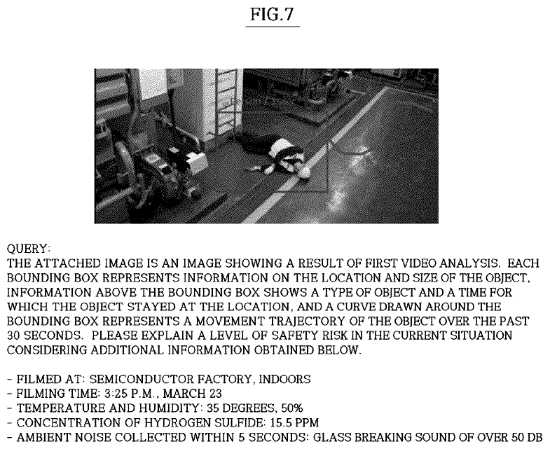

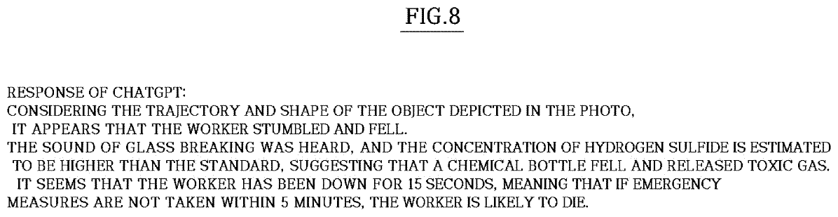

FIG. 7 is a diagram illustrating a query that further reflects multimodal information generated by the multimodal AI analyzer of the intelligent security system according to the present invention, and FIG. 8 is a diagram illustrating a response of the generative AI to a query that further reflects multimodal information generated by the multimodal AI analyzer of the intelligent security system according to the present invention.

Still video in which object description graphic information is graphically annotated is included in a part above the query illustrated in FIG. 7, and text reflecting object description text information and multimodal information is included on a lower side. In the text on the lower side of FIG. 7, a part having temperature and humidity, hydrogen sulfide concentration, and ambient noise is a part reflecting multimodal information generated by the multimodal AI analyzer.

FIG. 8 illustrates a response of the generative AI to a query that further reflects multimodal information, and it can be seen that a response is generated by clearly analyzing intent of a query reflecting still video in which graphic information is graphically object description annotated, object description text information, and multimodal information.

As described above, the intelligent security system according to the present invention may generate a more specific query about a situation in which video is captured and query the generative AI to be able to reduce ambiguity in result analysis different from intent, thereby more accurately identifying a security event. Therefore, it is possible to improve video security performance.

The intelligent security system according to the present invention may generate a more specific query about a situation in which video is captured and query the generative AI to be able to reduce ambiguity in result analysis different from intent, thereby identifying a more accurate security event. Therefore, there is an effect of improving video security performance.

The various embodiments disclosed in this specification and drawings are merely specific examples for aiding in understanding and are not intended to limit the scope of the various embodiments of the present invention. Therefore, the scope of the various embodiments of the present invention should be interpreted as including all changes or modifications derived based on the technical idea of the various embodiments of the present invention in addition to the embodiments described herein.

The present industrially applicable to technical fields related to the intelligent security system and technical fields applied thereto.

What is claimed is:

1. An intelligent security system comprising:
an artificial intelligence (AI) video analyzer configured to process a video signal input from a camera and generate object description information that describes an object included in the video;
an intelligent query generator configured to generate a query including a description of the video from the object description information output by the AI video analyzer; and
a security event processor configured to input the query generated by the intelligent query generator to generative AI, process a response by the generative AI, and identify a security event.

2. The intelligent security system according to claim 1, wherein the AI video analyzer comprises:
an object recognition unit configured to process the video signal input from the camera and extract an object included in the video;
an object description text generation unit configured to generate object description text information describing the object extracted by the object recognition unit;
an object description graphic generation unit configured to generate object description graphic information describing the object extracted by the object recognition unit;
an object description graphic editing unit configured to display an area of the object extracted by the object recognition unit as a bounding box in at least one piece of still video extracted from the video signal and to process a graphic annotation by adding the object description graphic information generated by the object description graphic generation unit to a region around the area of the object displayed as the bounding box in the still video; and
an object description information output unit configured to output the object description text information generated by the object description text generation unit and the object description graphic information graphically annotated by the object description graphic editing unit to the intelligent query generator.

3. The intelligent security system according to claim 2, wherein the object description graphic information comprises a graphic that indicates a movement line of the object.

4. The intelligent security system according to claim 1, wherein the security event processor comprises:
a parsing unit configured to parse a response from the generative AI to extract security-related keywords;
a security event identification unit configured to analyze the security-related keywords extracted by the parsing unit to determine whether a specific security event has occurred; and
a security event response unit configured to output response information for the security event that has occurred when the security event identification unit determines that the specific security event has occurred.

5. The intelligent security system according to claim 1, further comprising a multimodal AI analyzer configured to process sensing information input from at least one sensor node, generate multimodal information, and output the multimodal information to the intelligent query generator.

6. The intelligent security system according to claim 5, wherein the sensor node comprises at least one of an acoustic sensor for detecting sound, an olfactory sensor for detecting smell, a distance sensor for detecting distance, a temperature sensor for detecting temperature, a humidity sensor for detecting humidity, an illuminance sensor for detecting illuminance, and a concentration sensor for detecting concentration.

7. The intelligent security system according to claim 6, wherein the multimodal AI analyzer generates multimodal information comprising at least one of sound description information obtained by analyzing an acoustic signal input from the acoustic sensor, smell description information obtained by analyzing a smell signal input from the olfactory sensor, distance description information obtained by analyzing a distance signal input from the distance sensor, temperature description information obtained by analyzing a temperature signal input from the temperature sensor, humidity description information obtained by analyzing a humidity signal input from the humidity sensor, illuminance description information obtained by analyzing a humidity signal input from the illuminance sensor, or concentration description information obtained by analyzing a concentration signal input from the concentration sensor.
